(19) United States
(12) Patent Application Publication
(10) Pub. No.: US 2024/0272447 A1
(43) Pub. Date: Aug. 15, 2024

(54) PLANAR MULTI LAYERED THIN COMBINER

(71) Applicant: Spectralics Ltd., Tel Aviv (IL)

(72) Inventors: Yuval KASHTER, Tel Aviv (IL); Ran BAR-YOSEF, Ramat Gan (IL); Eran FALEK, Netanya (IL)

(73) Assignee: Spectralics Ltd., Tel Aviv (IL)

(21) Appl. No.: 18/626,489

(22) Filed: Apr. 4, 2024

Related U.S. Application Data
(63) Continuation of application No. PCT/IL22/51070, filed on Oct. 6, 2022.
(60) Provisional application No. 63/253,141, filed on Oct. 7, 2021.

(51) Int. Cl. G02B 27/28; G02B 27/01; G02B 27/14

(52) U.S. Cl. CPC G02B 27/283; G02B 27/14; G02B 27/0101; G02B 2027/0194

(57) ABSTRACT

There is provided a layered combiner for manipulating optical polarization on toroid surfaces, e.g. for a head-up display applications comprising a Picture Generating Unit (“PGU”) the structure adapted to receive polarized light in p-polarization direction, from said PGU, said structure comprising a dielectric material further comprising: a first layer comprising a first wave-retarder, wherein the angle between the incidence angle and the optical axis of the wave-retarder satisfies a Brewster angle; a layer of PMLTC segments, wherein each of the segments acts as a Mangin mirror-type surface and a third layer comprising a second wave-retarder. The Mangin mirror-type surface is configured to modulate the reflection of incoming collimated light on the surface of the segment to provide a collimated wave front without toroidal aberration thereby providing an observer with an undistorted image.

### CROSS REFERENCE TO RELATED APPLICATION

This application is a Continuation application of PCT Application No. PCT/IL2022/051070 filed Oct. 6, 2022, claiming priority from U.S. Provisional Patent Application No. 63/253,141 filed Oct. 7, 2021, both of which are incorporated herein by reference in their entirety.

### FIELD OF INVENTION

The present invention relates generally to a planar multi-layered thin combiner configured to be implemented into dielectric materials and more particularly into toroid surfaces such as windshields. Such arrangements are operable to overlay graphics and/or data onto a wholly undistorted unmodified real-world view.

### BACKGROUND OF THE INVENTION

Planar reflective surfaces are commonly used to trace light without optical modulation, where any effect on the wavefront shape (such as wavefront distortion, optical aberrations) must be negligible. In recent years, with the evolvement of imaging systems and displaying units, the ability to project virtual images on a large aperture with compact sizes and elegant forms of systems is now possible more than ever.

One example for the projection of virtual images is disclosed in FIG. 1A and shows an imaging system in a new low volume Head-Up Display “HUD” system as known in the art. The system comprises a picture generation unit “PGU” including a projector and an optical diffuser to create a wavefront of collimated light. Commonly, the image can then be adjusted in size and reflected onto a surface by a HUD mirror, also known as a waveguide. Next, the wavefront of collimated light can be used to display an image on a surface, for example a windshield, of the HUD. FIG. 1B describes the physical principle of a light guide-based projecting unit. A flat partially reflective surface, e.g. a windshield, folds the light, which has been reflected by a HUD mirror, to an Eyebox (i.e., exit pupil), in which the observer can perceive the displayed images. According to this concept, the waveguide provides the ability to expand the size of the exit pupil (i.e., beam expander implementation), while maintaining the light collimated.

In order to implement the above-mentioned optical configuration in a car, for a HUD system, a windshield is commonly used as the partially reflective surface to refract the light to produce an Eyebox whose location is adjusted to the driver's eyes. Nowadays in most cars, the geometry of the windshield has a curvature; in many cases in the form of a toroid. As a result, the wavefront of the collimated light, that meets the windshield is being distorted, what may cause a decrease in image quality of the image seen by the driver. In particular, due to the transverse uniformity of the collimated light being reflected by the toroid windshield, the degree of distortion of the wavefront varies within different areas of the windshield as a result of the difference in distance of areas of the windshield to the driver's eyes. The projection of an image at the peripheral areas of a windshield leads to a longer distance from the windshield to the driver's eyes compared to a projection of an image at the central region of a windshield.

In FIG. 2A, an example of a non-symmetrical toroid-like surface is shown. In FIG. 2B, the corresponding phase distribution for the non-symmetrical toroidal surface of FIG. 2A is presented. When used as a lens, the complex phase distribution of the non-symmetrical toroidal surface is an astigmatism of the non-symmetrical toroidal surface as a result of deviation from spherical curvature. The deviation of the non-symmetrical toroidal surface further results in distorted images, as light rays that pass or are reflected at the surface are prevented from meeting at a common focus.

The occurrence of distorted images as a result of collimated light interacting with curved surfaces is further not limited to toroid surfaces, e.g. used in windshield-based cars' HUD, but further applies to a variety of Augmented Reality (AR) systems (such as head mounted device).

Thus, there is a need to provide for an optical element that can be implemented into toroid surfaces, such as windshields, and may reduce or remove distortion of collimated light.

### SUMMARY OF THE INVENTION

The following is a simplified summary providing an initial understanding of the invention. The summary does not necessarily identify key elements nor limit the scope of the invention, but merely serves as an introduction to the following description.

A planar multi-layered thin combiner “PMLTC” is disclosed herein. The planar multi-layered thin combiner comprises a plurality of planar connectable layers each having a separate active area which is coated with a partially reflective filter

The present invention provides a planar multi-layered thin combiner “PMLTC” for receiving and directing incident light, said PMLTC comprising: a first layer comprising a wave retarder; a second layer comprising a transparent dielectric material, said second layer comprising a plurality of planar segments each having a separate active area; wherein the incidence angle of the light and the optical axis of each segment satisfies a Brewster angle; wherein each segment comprises a partially reflective layer to reflect the s-polarization only and not the p-polarization; a third layer comprising a wave retarder.

In an embodiment, the two wave retarders are orientated perpendicular to each other.

In an embodiment, the PMLTC is configured for adhesion to a transparent surface.

In an embodiment, the plurality of PMLTC segments is embedded inside a transparent surface.

In an embodiment, the transparent surface is a window, windscreen or windshield.

In an embodiment, each segment of the plurality of PMLTC segments is a Mangin mirror-type surface.

In an embodiment, the PMLTC has a thickness of 1 millimeter or less.

In an embodiment, the PMLTC operable to transmit light, irrespective of viewing angle, without perceptible geometrical discontinuities in the form of one or more of: optical vignetting, distortion and scattering.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A illustrates an optical arrangement representing a light guide as a thin projecting unit. FIG. 1B schematically illustrates the physical principle of a light guide-based projecting unit.

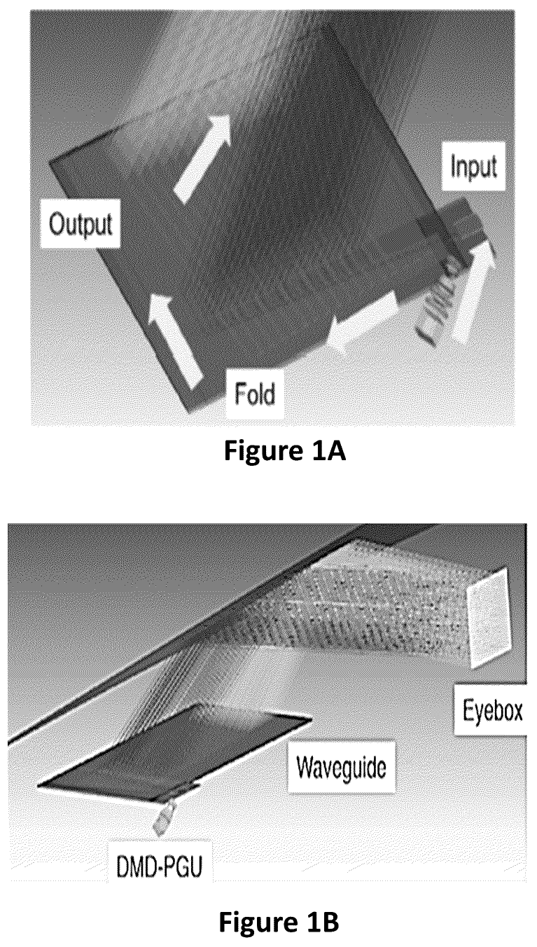

FIG. 2 illustrates an example of a toroid-like surface 2A and its corresponding phase distribution 2B.

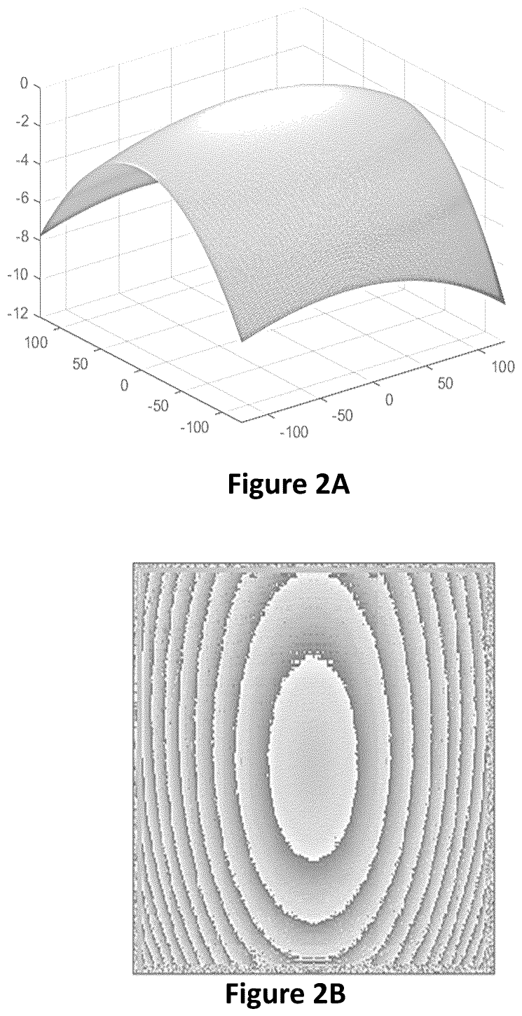

FIGS. 3A-3D are schematic diagrams and illustrate the distortion of collimated light by a toroidal element comprising two toroid surfaces.

FIG. 4 is a schematic diagram that illustrates the raytracing of collimate light wavefront by a toroid element including front toroidal and back toroidal surfaces S1 and S2 that are tilted at 1° angle to each other.

FIG. 5 is a schematic diagram and illustrates the raytracing of a collimated wavefront 504 that meets a partially reflective Mangin mirror-type surface S3 which is located between front toroidal surface S1 and back-toroidal surface S2 without a wedge-shaped cross-section between both toroidal surfaces.

FIGS. 6A-6D are schematic diagrams and illustrate the interaction of collimated light with a dielectric optical combiner comprising a curved surface 601.

FIG. 7 illustrates an example of a Mangin mirror-type correction surface 701 that intersects with the back surface 702 due to small thickness.

FIG. 8 is a schematic diagram and illustrates the PMLTC, consisting of three segments that are located in a medium with one mm thickness, according to embodiments of the present invention.

FIG. 9 illustrates the reduction of ghost images using the p-polarization method, according to embodiments of the present invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

The following term definitions are provided to aid in construal and interpretation of the invention.

The term “field of view” (FOV) is the open, observable arca a person can see through their eyes or via an optical device.

The term “Brewster angle” indicates an angle at which light incident on the boundary surface of two dielectric media is reflected only in the proportions that are polarized perpendicularly to the plane of incidence (in relation to the electric field component). The reflected light is then linearly (collimated) polarized. Thus, the Brewster angle is an angle of incidence at which light with a particular polarization is perfectly transmitted through a transparent dielectric surface with no reflection.

In this document an innovative solution for an equivalent planar combiner with negligible wavefront distortions is presented. The method is based on the recently invented concept named the Multi-Layered-Thin-Combiner disclosed in PCT application no. PCT/IL2019/051404 where the optical component compensates the optical path differences (OPDs) resulted from the geometry of the curved surface.

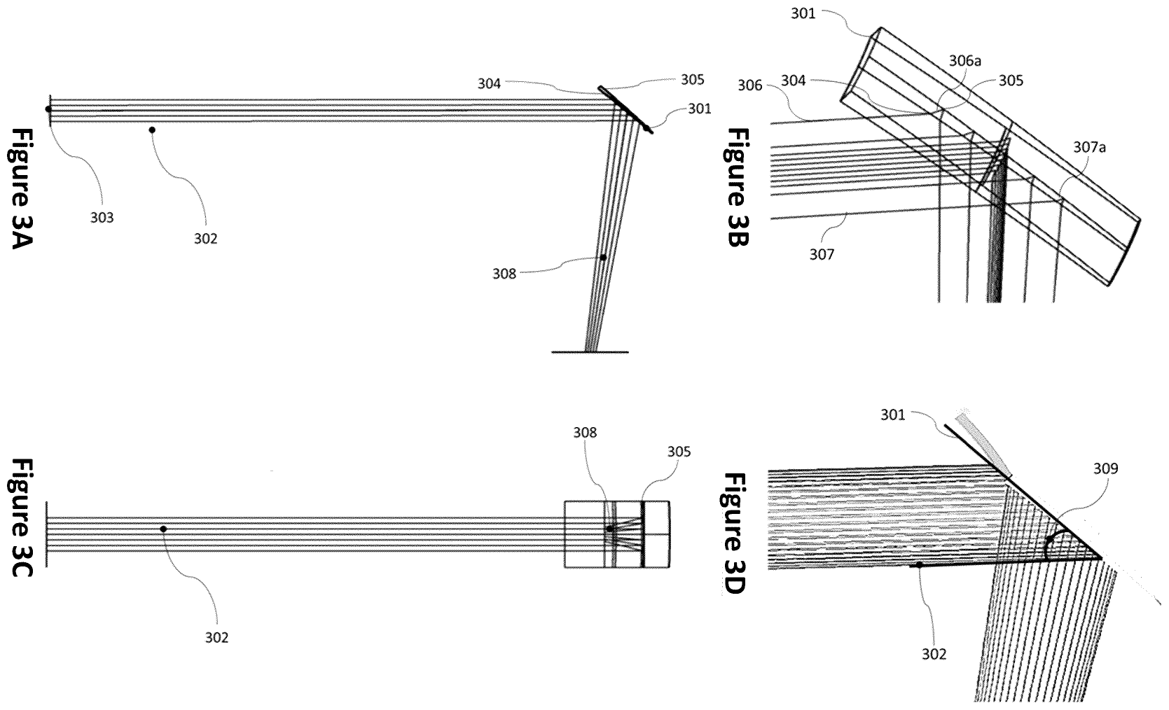

FIGS. 3A-3D, for example, illustrate the distortion of light by a wedge-shaped optical combiner with a curved surface (toroidal surface).

The toroidal element 301 described in FIG. 3A-3D contains two toroidal surfaces with arbitrary radii of 100 and 150 cm along the horizontal and vertical dimensions, respectively.

To simulate a form of a typical windshield, that is used as a HUD's combiner in a car, for example, the back and the front toroidal surfaces are tilted at 1°. The back and the front toroidal surfaces are tilted and form a wedge-shaped cross-section.

As shown in FIGS. 3A-3D, to simplify the light tracing of the collimated light 302, the incident angle of the collimated light meeting the front toroidal surface in in FIGS. 3A-3D is 45°.

FIG. 3A is a cross-section view of a toroidal element 301 that is exposed to collimated light from the z-direction. The collimated light from light source 303, e.g. a GPU of a HUD system, meets the toroidal element and is distorted by front toroidal surface 304 and back toroidal surface 305. The toroidal surfaces 304 and 305 distort incidence light 302 leading to a reflected wavefront of distorted light 308.

FIG. 3B provides a close-up view of the toroidal surface of FIG. 3A. As detailed in FIG. 3B, a ray 306 of collimated light 302 meets the front surface 304 of toroidal element 301 on its concave side, refracts (according to Snell's law), and penetrates toroidal element 301. The ray 306a of the collimated light transfers through the medium and reaches the back surface 305 of toroidal element the convex side where it is reflected back and travels through toroidal element 301 and reaches the front surface 304 where it diffracts leaving toroidal element 301.

As a result of the tilted back toroidal surface in relation to the front toroidal surface rays of light entering toroidal element 301 do not travel the same distance through toroidal element 301. For example, the distance 306a of light ray 306 travelled within 301 is longer compared to the distance 307a of light ray 307. The difference in travelled distance between toroidal surfaces 304 and 305 leads to non-uniform reflection angles in which light rays 306 and 307 are reflected from toroidal surface 305 and further results in a non-uniform diffraction upon leaving toroidal element 301 at front surface 304.

As a consequence of the non-uniform reflection at the back toroidal surface 305, the wavefront of light is distorted along the y and z axes, respectively and the wavefront is no longer collimated.

The distortion along the y and z axes is further illustrated in FIG. 3C. FIG. 3C provides an alternative view of the set-up disclosed in FIG. 3A, showing the toroid element 301 from the x-direction. Clearly, light beams of the collimated light 302 reflected from the toroidal element 301 experience a distortion that is dependent on the location of the hit of the collimated light 302 on the toroidal surfaces 305 resulting in a nonequal convergence along the y and z axes, respectively.

In FIG. 3D, the incident angle 309 formed by incident light 302 relative to the toroid element 301 is shown. In the automotive industry, in most windshield-based HUD systems the incident angle 309, in which collimated light 302 meets the windshield—in the example represented by front toroidal surface 301 commonly has a value of >60°. As one can expect, a larger incidence angle leads to an increased distortion of collimated light.

Additionally, the light that meets the front toroidal surface is also distorted as a result of reflection of incident light 302 at front toroidal surface 301. Therefore, two overlapped distorted images may be created. The larger the FOV, for example, the larger the windshield, the larger the distortion due to reflections occurring at the front or back toroidal surface and the more the quality of the image will be compromised.

In order to visually illustrate and to overcome reflections occurring at the front or back toroidal surface, the cross-section of the curved surface was analyzed by ray tracing of the incident light.

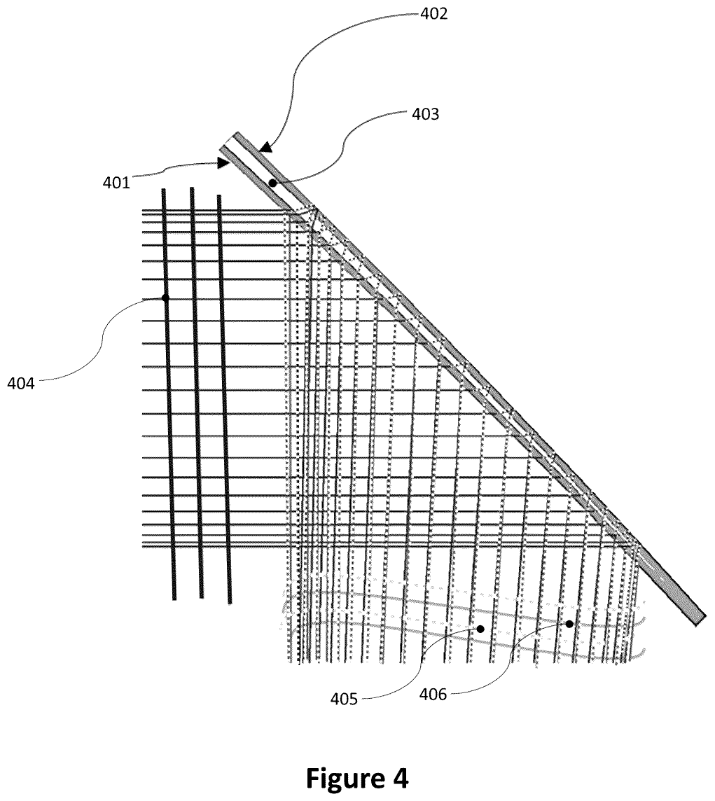

The illustration presented in FIG. 4 shows the distortion of incident collimated light by front toroidal and back toroidal surfaces 401 and 402 that are tilted by 1° angle to each other to form a wedge-shaped cross-section 403. Starting from a collimated wavefront 404 of incident light the ray tracing at the cross-section of the above-mentioned wedge-shaped cross-section 403, for example of a windshield, is disclosed. The incident light 404 that penetrates through the windshield is refracted by the front toroidal surface 401, meets the back toroidal surface 402 and is reflected by the back toroidal surface 402 leading to distorted wavefront 405 as a result of the tilted arrangement of front toroidal surface 401 and back toroidal surface 402, as outlined in FIGS. 3A-3D. Moreover, a secondary image is observed that results from a reflection of the incidence light 404 from the front toroidal surface 401. Since both toroidal surfaces 401 and 402 are slightly tilted to each other, the distortion due to the reflection by front toroidal surface 401 is different to the distortion observed for back toroidal surface 402 leading to a second distorted wavefront 406. Wavefronts 405 and 406 may partially overlap resulting in two partially overlapping images. An observer, for example a driver of a car, being exposed to a combination of two distorted and partially overlapping images may not be able to identify information provided by the images.

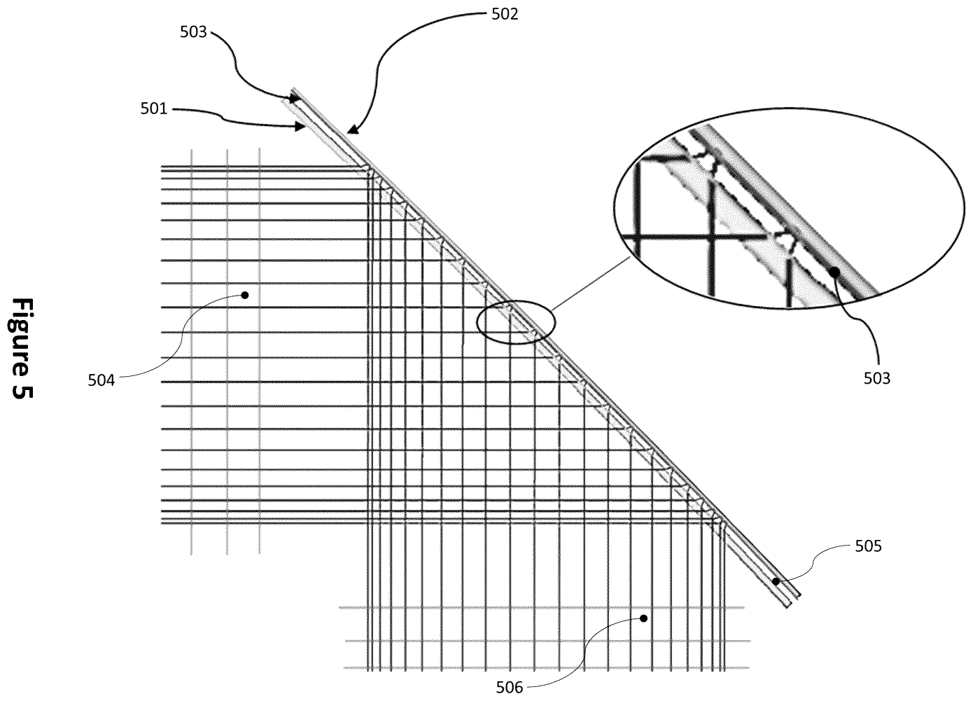

A previously developed solution that prevents or reduces the distortion of collimated 504 light that occurs at the back toroidal surface 502 is shown in FIG. 5.

In order to correct the above-mentioned wave front distortion, as a result of the differences in reflection angles observed at the back toroidal surface 502, an additional internal surface 503, comprising a partially reflective coating is laminated inside the transparent dielectric material (e.g., glass). The additional internal surface is commonly referred to as a Mangin mirror-type surface 503. The compensation for the difference in reflection angle, as outlined in FIGS. 3A-3D, at the back toroidal surface 502 is achieved by the nonsymmetric shape of 503, wherein the shape of additional internal surface 503 is defined by a polynomial that could be calculated by commonly used optimization methods exist in commercial optical design software (for example Zemax, Code V).

The illustration presented in FIG. 5 shows the raytracing of a collimated wavefront 504 that meets a partially reflective Mangin mirror-type surface 503 which is located between front toroidal surface 501 and back-toroidal surface 502 without a wedge-shaped cross-section between both toroidal surfaces.

In the present example, incident light 504 reaches the front toroidal surface 501 at an angle of about 45°, penetrates 501 and propagates inside the dielectric medium 505. The light exits surface 501 as a distorted wavefront and reaches the partially reflective Mangin mirror-type surface 503. The distorted wavefront is reflected by the partially reflective layer of the Mangin mirror-type surface 503 (e.g., an optical filter) and exits surface 503 at a modulated angle. Upon reaching surface 501, the wavefront is refracted at an angle of 45° according to Snell's law that corresponds to the angle of the incident light wavefront 504 meeting surface 501. The Mangin mirror-type surface 503 is configured to cancel out the toroidal aberration produced by the reflection on back toroidal surface 502. The Mangin mirror-type surface 503 is a reflective surface that behaves like a curved mirror and reflects light without toroidal aberration. Thus, the light that is modulated by the Mangin mirror 503 does not affect the wavefront.

The shape of the Mangin mirror can be adjusted to a toroidal surface via the calculation of a polynomial function defining the curvature of the Mangin mirror in relation to the toroidal surface. Due to provision of a Mangin mirror-type surface based on calculated coefficients in relation to the curvature of the toroidal surface, the overall optical power along the Mangin mirror is approximately zero. Hence, the Mangin mirror in general is an equivalent folding mirror (planar mirror) with negligible wavefront distortion.

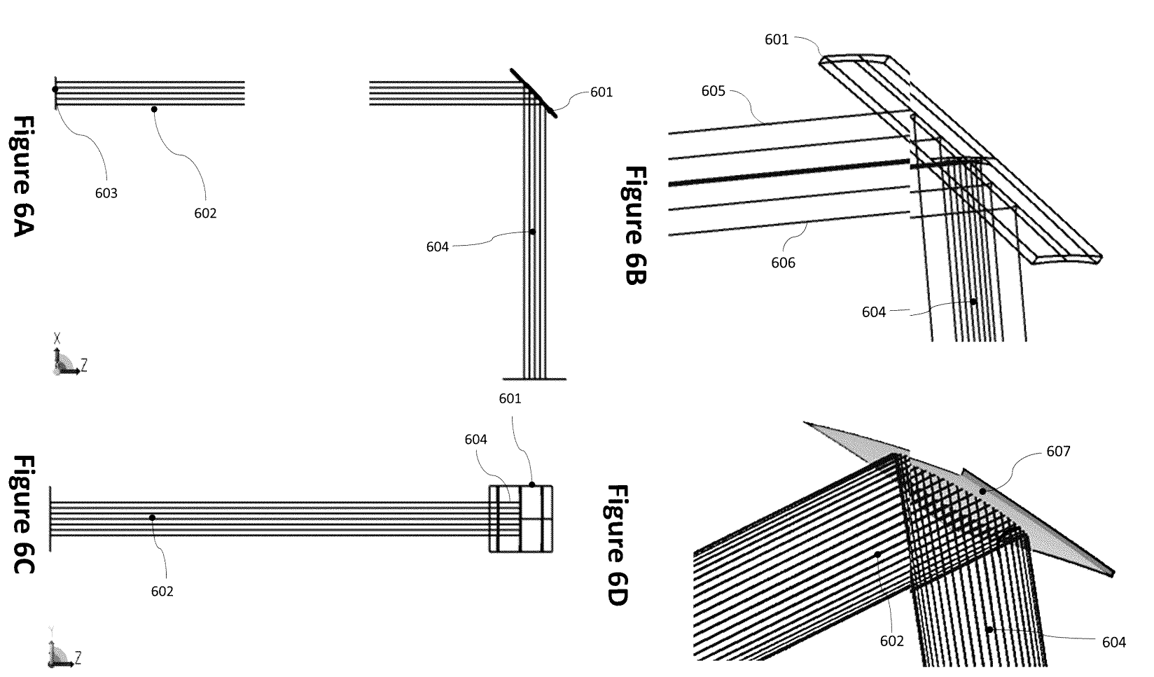

In FIGS. 6A-6D, the interaction of collimated light 602 from collimate light source 603 with a dielectric optical combiner comprising a curved surface 601 is detailed.

As shown in FIG. 6A, a collimated light wavefront 602 travelling in the direction of optical combiner 601 meets the curved surface of the optical combiner, diffracts by entering into the dielectric material of the optical combiner and reaches the toroidal back surface where it reflects, resulting in a distorted wavefront. However, leaving the dielectric optical combiner, the distorted wavefront passes the curved front surface a second time, cancelling out spherical aberration by the opposite spherical aberration produced by the collimated light traveling through the concave lens resulting in an equal convergence along the y and z axes, respectively and the provision of a collimated light wavefront 604.

FIG. 6B provides a close-up view of the optical combiner surface 601 of FIG. 6A. As detailed in FIG. 6B, equal convergence along the y and z axes for incoming collimated light 604, for examples rays 605 and 606 passing optical combiner 601 and being reflected by the combiner at various locations, is observed.

The equal convergence along the y and z axes is further illustrated in FIG. 6C. FIG. 6C provides an alternative view of the set-up disclosed in FIG. 6A, showing the optical combiner 601 from the x-direction. Clearly, light beams of the collimate light 604 reflected from the optical combiner 601 experience non or negligible distortion that is independent from the location of the hit of the collimated light 602 on the optical combiner 601 resulting in an equal convergence along the y and z axes, respectively.

FIG. 6D provides a further illustration of collimated light 602 being reflected by Mangin-mirror type surface 607 leading to the emission of collimated light 604.

The curved surface of an optical combiner may be expressed as an extended polynomial consisting of only two orders, where the symmetry along the vertical direction breaks due to the off-axis problem.

In line with the ray tracing result as detailed in FIG. 5, one can realize that the characteristics of the collimated light leaving an optical combiner comprising a Mangin mirror-type surface remains the same without any significant modulation. Therefore, as mentioned before, although the optical combiner comprises curved surfaces, it behaves like a planar folding mirror.

In many applications, and in particular in a windshield-based HUD, thin optical combiners are required. However, the degree of curvature of a windshield and the degree of curvature of a surface, e.g. surface required to reflect collimated light without any significant modulation thereby acting as a Mangin mirror, can be entirely different. Thus, the surfaces of windshield and Mangin mirrors may overlap.

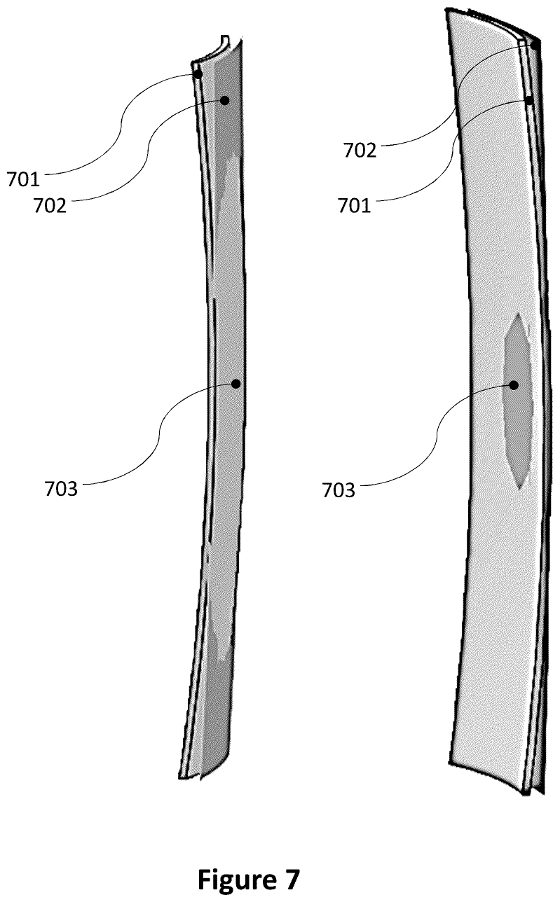

In FIG. 7, an example of a Mangin mirror-type correction surface 701 that intersects with the back surface 702 (intersection shown in surface 703) due to small thickness is shown in two different orientations. Consequently, according to the geometry of windshields, it is impossible to implement the above mentioned Mangin mirror that enables the correction of the distorted wavefront, into a windshield. As a result, Mangin mirror-type surfaces can only be introduced into windshields that comprise specific toroid structures in which a Mangin-mirror type surface does not intersect with the dielectric material of the windshield leading to a limitation in the introduction of Mangin-mirror type surfaces in windshields in the automotive industry.

The present invention solves the limitation of introducing Mangin-mirror type surfaces in, curved surfaces of dielectric materials, e.g. windshields. Further, the present invention provides a segmented form of a Mangin-mirror type correction surface named the Planar-Multi-Layered-Thin-Combiner (PMLTC).

The PMLTC comprises a number of segments that are introduced into a dielectric material, for example, a windshield of a car, van, helicopter, etc.

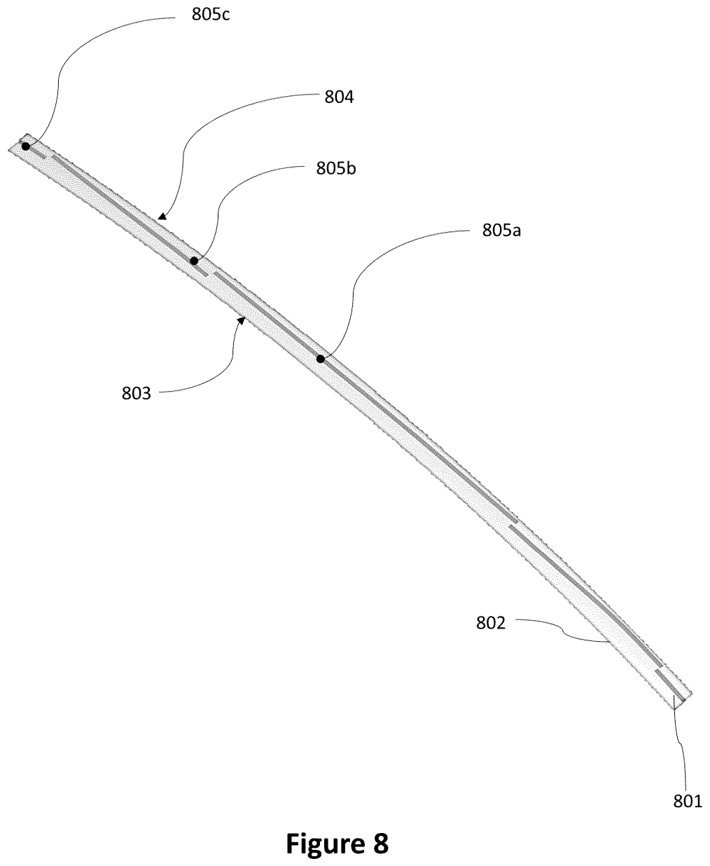

FIG. 8 shows a cross-section view of a toroidal, transparent dielectric material 801 comprising a front toroidal surface 803 and a back toroidal surface 804. The toroidal, transparent dielectric material 802 comprises three segments 805a, 805b and 805c. Each of the segments are arranged between the front toroidal surface 803 and the back toroidal surface 804.

The transparency of the dielectric material 801 is not affected by the structure of the PMLTC elements, since the PMLTC segments within the dielectric material 802 are arranged in a way to form a continues layer of individual segments throughout the dielectric material 802. In each of the PMLTCs, the segments 805a. 805b and 805c are less curved than the external surface of toroidal surfaces 803 and 804, and thus, the introduction of multiple segments within the axial direction of dielectric material 802 is required. In the illustration presented in FIG. 8, three segments provide the ability to implement the Mangin-mirror type surface in a segmented form. The introduction of segments allows to implement segments that fulfill the above mentioned Mangin mirror and enable the correction of the distorted wavefront on toroid surfaces.

In particular, the separation of a Mangin-mirror type surface into segments 805a, 805b and 805c enables the introduction of correction surfaces into dielectric materials, e.g. windshields, that exhibit a strong curvature.

In an embodiment, the curvature of a windshield is 30°, 35°, 40°, 45°, 50°, 55°, 60°, 65°, 70°, 75°, 80°, 85° or 90°. In an embodiment the curvature of a windshield is >40°. In an embodiment, the curvature of a windshield is >45°. In an embodiment, the curvature of a windshield is >60°. In an embodiment, the windshield is a front windshield. In an embodiment, the windshield is a back windshield. In an embodiment, the windshield is a side windshield. In an embodiment, the windshield is implemented in the roof of a vehicle.

In optical combiners, ghost images, created by straylight, might be created from secondary reflections from different surfaces that are not supposed to be involved in the optical arrangement. In the above-mentioned concept two additional reflections might occur from toroid surfaces 803 and 804 leading to two distorted ghost images.

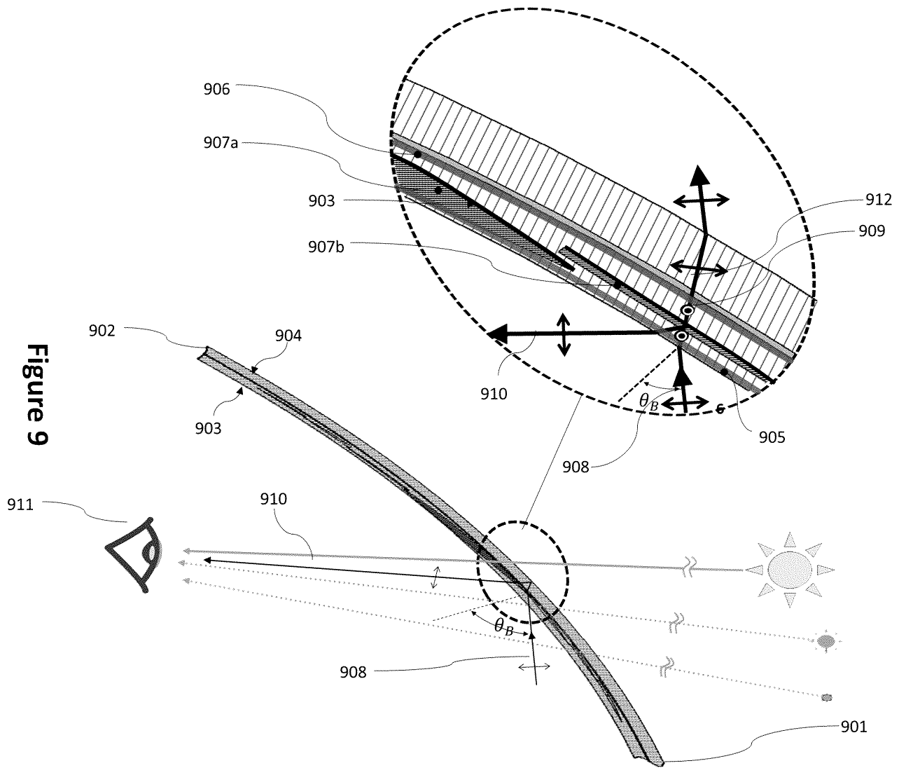

In FIG. 9, a cross-section view of a toroidal, transparent dielectric material 901 comprising a front toroidal surface 903 and a back toroidal surface 904 is detailed. The toroidal, transparent dielectric material 902 comprises a plurality of segments, such as segments 907a and 907b. Each of the segments is arranged between the front toroidal surface 903 and the back toroidal surface 904. The segments are arranged within the transparent dielectric material 902 so that the optical x-axis for each segment and the incidence angle θ of collimated incidence light 908 is equal to the Brewster angle θB.

To reduce or remove ghost-images from secondary reflections, for example, dielectric surfaces 903 and 904 of FIG. 9, two wave retarders 905 and 906 that are orientated perpendicular to each other are introduced, in addition to PMLTC segments into a dielectric material 902, as detailed in FIG. 9.

The first wave retarder 905 and the second wave retarder 906 are optical devices that alter the polarization state of a light wave front travelling through it. Both wave retarders, the first wave retarder 905 and the second wave retarder 906, are half-wave plate retarders (λ/2). A half-wave plate retarder shifts the polarization of linearly polarized light by half of the wave-length.

According to embodiments of the present invention, in FIG. 9, p-polarized, collimated light (originated at the PGU) 908 meets the inner surface 903 (at the Brewster angle), refracts (according to Snell's law), and penetrates to the inner layer of surface 903. A first λ/2 wave retarder 905 is placed between the inner surface 903 and the PMLTC segments 907b, where its slow axis is oriented with 45° with respect to the p-polarized polarization direction. The polarization of the light is rotated by 90° and it is now s-polarized 909. Consequently, the portion of the light that meets the partially reflective PMLTC segments 907b is now s-polarized. Next, light 909 that is reflected back by the PMLTC transmits through the wave-retarder 905, its polarization orientation is rotated by 90° and it is now back to being p-polarized, refracts at surface 903, and traced 910 to the observer's eye 911 (with a negligible secondary reflection).

The Mangin mirror-type surface of each of the segments 907 is configured to cancel out the toroidal aberration and each segment of the Mangin mirror-type surface 907 is a reflective surface that behaves like a curved mirror and reflects light without toroidal aberration. Thus, the light 910 that is modulated by the Mangin mirror-type segment 907b and is traced back to the observer's eye 911 is collimated light.

The portion of the light that passed through the partially reflective segment 907b transmits through a second λ/2 wave-retarder 906 (named the outer wave-retarder), where its slow axis is oriented by 45° relative to the s-polarization direction (and orthogonal to the slow axis of the inner wave retarder 905). The transmitted light 912 is rotated by 90°, and it is back to being p-polarized. Finally, it is refracted (at surface 904) to the air, where it is p-polarized (due to the Brewster angle in the air, the reflection from the boundary layer 904 is negligible).

The use of the two orthogonal wave-retarders of the present invention provides the ability to exploit the larger reflection efficiency of the filter to s-polarized light, whilst eliminating secondary images of strong external illumination sources (located in large angles relative to the windscreen's normal) that are expected to be developed due to stray-light that will be reflected by the PMLTC effective segments. By doing so, the present invention provides a thin element with optical power and an efficient reflectance, whilst the PMLTC segments are almost indistinguishable, due to a low average reflectance. Additionally, the power of the secondary images of strong illumination sources is minimized.

Each of the inner and outer wave-retarders may be cemented to a dielectric material, for example glass, by an index matching medium.

Locating the light source in the Brewster angle (the chief ray is ˜57º with respect to the incident angle of the glass) will allow to discard any minor reflections from surface 903. Additionally, two perpendicular wave retarders may enable to design an s-polarization based coating, while any reflection from surface 904 will be discarded as well. By doing so, an efficient filter with minimal average reflection can be produced with negligible ghost images.

Thus, the arrangement as disclosed in FIG. 9, comprising the implementation of two wave retarders that are perpendicular orientated to each other, in combination with a plurality of segments that reflect the s-polarization but not the p-polarization leads to the provision of an efficient ghost-less reflector.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A planar multi-layered thin combiner (PMLTC) for receiving and directing incident light, said PMLTC comprising:
a first layer comprising a wave retarder;
a second layer comprising a transparent dielectric material, wherein said second layer comprising a plurality of planar segments each having a separate active area, wherein the incidence angle of the light and the optical axis of each segment satisfies a Brewster angle, and wherein each segment comprises a partially reflective layer to reflect the s-polarization only and not the p-polarization; and
a third layer comprising a wave retarder.

2. The PMLTC according to claim 1, wherein said two wave retarders are orientated perpendicular to each other.

3. The PMLTC according to claim 1, wherein the PMLTC is configured for adhesion to a transparent surface.

4. The PMLTC according to claim 1, wherein the plurality of PMLTC segments is embedded inside a transparent surface.

5. The PMLTC according to claim 3 or 4, wherein the transparent surface is a window, windscreen or windshield.

6. The PMLTC according to claim 4, wherein each segment of the plurality of PMLTC segments is a Mangin mirror-type surface.

7. The PMLTC according to claim 1, wherein the PMLTC has a thickness of 1 millimeter or less.

8. The PMLTC according to claim 1, operable to transmit light, irrespective of viewing angle, without perceptible geometrical discontinuities in the form of one or more of: optical vignetting, distortion and scattering.
